(19) United States
(12) Patent Application Publication
(10) Pub. No.: US 2012/0088448 A1
(43) Pub. Date: Apr. 12, 2012

(54) INFORMATION PROCESSING APPARATUS AND METHOD OF CONTROLLING FOR INFORMATION PROCESSING APPARATUS

(75) Inventor: Hideyuki NAKAGAWA, Fuchu-shi (JP)

(73) Assignee: KABUSHIKI KAISHA TOSHIBA, Tokyo (JP)

(21) Appl. No.: 13/212,873

(22) Filed: Aug. 18, 2011

(30) Foreign Application Priority Data
Oct. 8, 2010 (JP) 2010-228958

(51) Int. Cl. H04B 5/00

(52) U.S. Cl. 455/41.1

(57) ABSTRACT

According to one embodiment, an information processing apparatus includes a communication module, a detector and a controller. The communication module is configured to execute proximity wireless communication. The detector is configured to detect whether an external device capable of executing proximity wireless communication with the communication module is in a proximity state. The controller is configured to control execution of a series of operations includes a plurality of steps based on detection of the proximity state and detection of a state other than the proximity state by the detector.

### CROSS-REFERENCE TO RELATED APPLICATIONS

This application is based upon and claims the benefit of priority from Japanese Patent Application No. 2010-228958, filed Oct. 8, 2010, the entire contents of which are incorporated herein by reference.

### FIELD

Embodiments described herein relate generally to an information processing apparatus which executes proximity wireless communication, and a controlling method applied to the information processing apparatus.

### BACKGROUND

Wireless communication such as near-field communication (NFC) has been widely used in recent years. As such wireless communication has become popular, the user can easily effect communication for authentication, accounting, etc., simply by placing an integrated circuit (IC) card or cellphone over a reader/writer of a host system.

Recently, proximity wireless communication has been developed to enable higher-speed communication. The proximity wireless communication enables transmission of desired document, video, and audio data as well as authentication and accounting simply by moving two devices close to each other.

It is now assumed that devices A and B including a proximity wireless communication function are placed close to each other (ready to effect proximity wireless communication), and cooperate to sequentially execute functions 1 and 2. Only the function 1 may be wanted to execute. In this case, it is necessary to provide a function (a) to accept setting for executing the function 1 only before moving the devices A and B close to each other, and a function (b) to ask “Execute function 2?” and receive the answer before starting the function 2 after completion of the function 1. In other words, the user is required to take any action in addition to simply moving the devices close to each other.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a proximity wireless communication executed by a proximity wireless communication system using an information processing apparatus according to an embodiment.

FIG. 2 is an exemplary diagram showing a system configuration of the information processing apparatus according to the embodiment.

FIG. 3 is an exemplary conceptual diagram for explaining the operation principle of the information processing apparatus according to the embodiment.

FIG. 4 is an exemplary flowchart showing an operation procedure of the information processing apparatus according to the embodiment.

FIG. 5 is an exemplary diagram for explaining a first application example executable by the proximity wireless communication system using the information processing apparatus according to the embodiment.

FIG. 6 is an exemplary first diagram for explaining a second application example executable by the proximity wireless communication system using the information processing apparatus according to the embodiment.

FIG. 7 is an exemplary second diagram for explaining the second application example executable by the proximity wireless communication system using the information processing apparatus according to the embodiment.

FIG. 8 is an exemplary diagram for explaining a modification of the second application example executable by the proximity wireless communication system using the information processing apparatus according to the embodiment.

### DETAILED DESCRIPTION

Various embodiments will be described hereinafter with reference to the accompanying drawings.

In general, according to one embodiment, an information processing apparatus includes a communication module, a detector and a controller. The communication module is configured to execute proximity wireless communication. The detector is configured to detect whether an external device capable of executing proximity wireless communication with the communication module is in a proximity state. The controller is configured to control execution of a series of operations comprising a plurality of steps based on detection of the proximity state and detection of a state other than the proximity state by the detector.

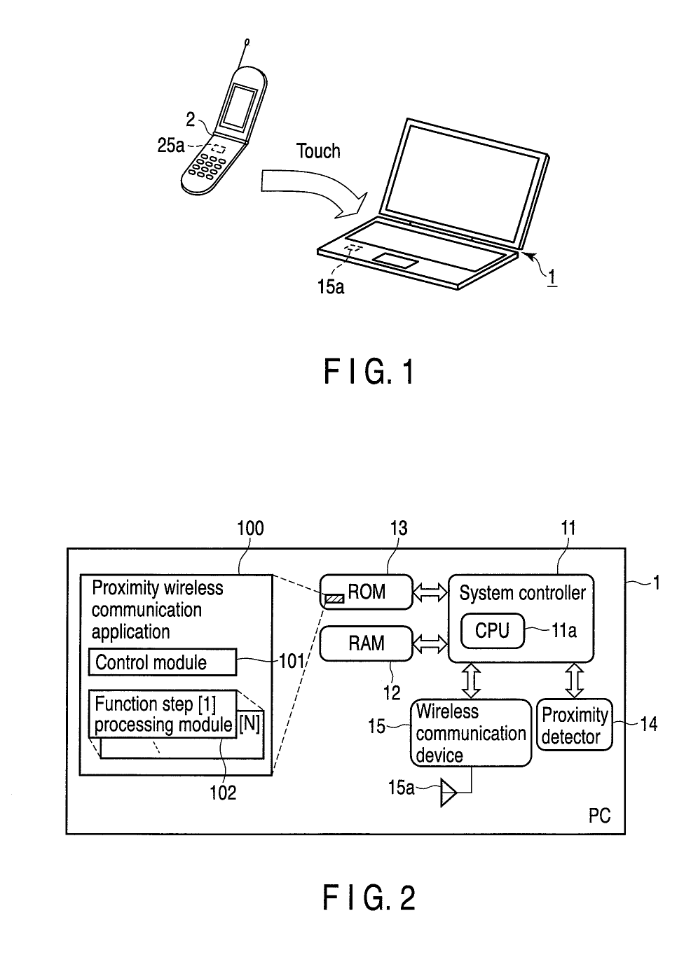

FIG. 1 is an exemplary diagram showing a proximity wireless communication executed by a proximity wireless communication system using an information processing apparatus according to an embodiment.

As shown in FIG. 1, a proximity wireless communication system includes a notebook computer (PC) 1, and a cellphone 2. The PC 1 and cellphone 2 include a proximity wireless communication function. The PC 1 is provided with an antenna (coupler) 15a for proximity wireless communication. The cellphone 2 is provided with an antenna (coupler) 25a for proximity wireless communication. Data transmission is possible between the PC 1 and cellphone 2 simply by placing the cellphone 2 closely over the PC 1 as if touching coupler 25a to coupler 15a.

That is, both PC 1 and cellphone 2 are information processing apparatuses according to the embodiment. When the PC 1 and cellphone 2 are placed close to each other, they cooperate to execute a predetermined operation (accompanied by data transmission). Here, the “predetermined operation” includes a plurality of steps (function steps). More specifically, when the cellphone 2 is placed over the PC 1, a function step [1] is started. When function step [1] is completed, next function step [2] is started. When last function step [N] is completed, the “predetermined operation” including a plurality of steps is completed.

Here, it is assumed that the “predetermined operation” includes a case where only step [1] is wanted to execute, for example. That is, the “predetermined operation” includes a case where steps up to [M] (M<N) are wanted to execute. The information processing apparatus according to the embodiment is configured to control the process (execution) of the “predetermined operation” including a plurality of steps, only by simple actions of moving two devices close to each other and separating. This will be described in detailed hereinafter.

FIG. 2 is an exemplary diagram showing a system configuration of the information processing apparatus (PC 1) according to the embodiment. As described above, both PC 1 and cellphone 2 shown in FIG. 1 are information processing apparatus according to the embodiment. In the following description about the system configuration, the PC 1 is taken as an example. The cellphone 2 is substantially the same as the PC 1, and an explanation thereof is omitted.

As shown in FIG. 2, the PC 1 includes a system controller 11, a RAM 12, a ROM 13, a proximity detector 14, and a wireless communication device 15.

The system controller 11 includes a CPU 11a, and a system bus (not shown). The system controller 11 executes various programs stored in the ROM 13, by the CPU 11a using the RAM 12 as a work area. The RAM 12 is a memory to store data under processing and stack. The ROM 13 is a memory to store a driver to control various application programs and components shown in the FIG. 2. Various application programs include, for example, document preparation software, spreadsheet software, browser, mailer, and content reproduction software. In the information processing apparatus of the embodiment, a proximity wireless communication application program 100 (described later) is used as one of various application programs.

The proximity detector 14 is a sensor to detect a proximity state, when the proximity detectors of a main unit (PC 1) and an external device (cellphone 2) are placed close to each other. The information processing apparatus of the embodiment controls the process (execution) of each function step of the proximity wireless communication application program 100, based on the data from the proximity detector 14. As a means of realizing the control, there are TransferJet (registered trademark), FeliCa (registered trademark), an IC chip, and a contactless charging device, for example. A device with severe alignment is unsuitable, because it limits a communicable range of a wireless communication device.

The wireless communication device 15 is a module to effect wireless data communication with an external device (cellphone 2) via the coupler 15a in a proximity state. The TransferJet, FeliCa, and IC chip include the same functions as the proximity detector 14 and wireless communication device 15. Particularly, the TransferJet is preferable for handling a large size data.

The proximity wireless communication application program 100 executed on the information processing apparatus (PC 1) with the above configuration includes a control module 101, and a plurality of function step processing modules 102. When the proximity detector 14 detects the proximity to a proximity detector of an external device (cellphone 2), the system controller 11 starts execution of the proximity wireless communication application program 100. When the proximity wireless communication application program 100 is started, the function step processing modules 102 are sequentially executed in chronological order.

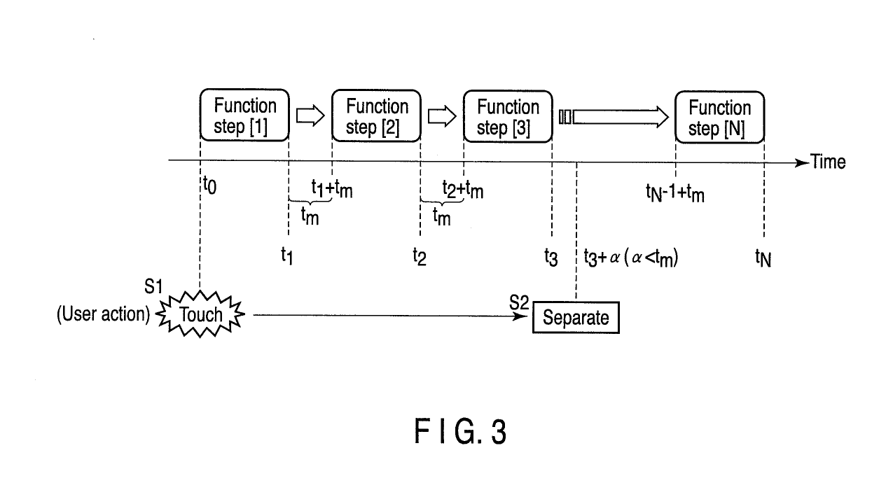

FIG. 3 is an exemplary conceptual diagram for explaining the operation principle of the information processing apparatus of the embodiment. In FIG. 3, function step [1] indicates a process (function step) executed by the function step [1] processing module 102 of the proximity wireless communication application program 100. That is, FIG. 3 shows that the function steps [1] to [N] are sequentially executed in chronological order.

It is assumed that the cellphone 2 is placed over the PC 1 at time t0 (s1 in FIG. 3), and the proximity wireless communication application program 100 is started. Then, the control module 101 activates the function step [1] processing module 102 to execute function step [1] (at time t0). Function step [1] is to be completed at time t1. When function step [1] is completed, the next function step [2] processing module 102 is usually started at once. The control module 101 provides an interval (time period tm) between the end of the previous step and the start of the next step. That is, the control module 101 waits the time period tm, and activates the function step [2] processing module 102 at time t1+tm.

Similarly, when function step [2] is completed at time t2, the control module 101 activates the function step [3] processing module 102 after the interval (at time t2+tm). Further, when function step [3] is completed at time t3, the control module 101 activates the function step [4] processing module 102 after the interval (at time t3+tm). In this way, the control module 101 controls the processing modules 102 until the final function step [N] processing module 102 is activated, by providing a predetermined interval between function steps. Whenever each function step is completed, the control module 101 emits sound, light, or message (through a speaker or display provided in an information processing apparatus), and notifies the user of the completion of each function step.

It is assumed that a certain user wants to execute function steps from function step [1] to function step [3] which is halfway function step. For such a user, the control module 101 provides the above interval between function steps. When the proximity detector 14 detects the dissolving of the proximity to a proximity detector of an external device (cellphone 2), the system controller 11 makes it known to the control module 101 of the proximity wireless communication application program 100. When receiving the notice during a predetermined interval (time period tm) after completion of certain function step, the control module 101 finishes the proximity wireless communication application program 100 without activating the subsequent function step.

The above user (wanting to execute function steps [1] to [3]) can start the proximity wireless communication application program 100 by touching the cellphone 2 to the PC 1, as above described. Then, function steps are sequentially executed from step [1], and whenever each function step is completed, sound, light, or message is emitted to notify the completion of each function step. Therefore, when the sound, light, or message is emitted third times (time t3), the user can stop the proximity wireless communication application program 100 by separating the cellphone 2 from the PC 1 (s2 in FIG. 3) during time period tm, and finish the program 100 after executing object function steps [1] to [3].

A predetermined interval or time period tm is preferably set to time within which the user can separate the cellphone 2 without haste from the PC 1 after recognizing the completion of a certain function step.

That is, the information processing apparatus can control a process (execution) of a predetermined operation including a plurality of steps only by simple actions of touching and separating the cellphone 2 and PC 1, without it is necessary to provide a function (a) to accept setting for executing a certain function before moving the cellphone 2 close to the PC 1, and a function (b) to ask “Execute the next function?” and receive the answer before starting a subsequent function step after completion of a previous step.

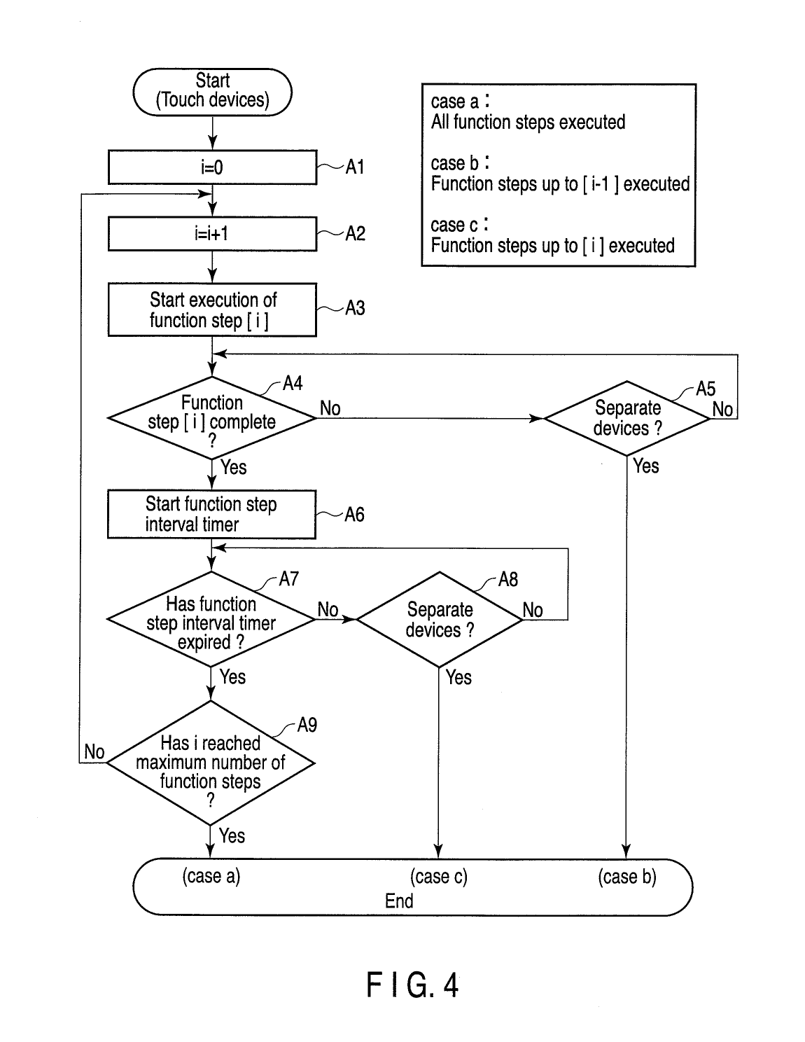

FIG. 4 is an exemplary flowchart showing an operation procedure of the information processing apparatus according to the embodiment.

When information processing apparatuses including a proximity wireless communication function are placed close to each other, the information processing apparatuses reset a function step number [i] to be executed to an initial value 0 (block Al). Then, the information processing apparatuses increment the function step number [i] by one (block A2), and execute function step [i].

When function step [i] is completed (YES in block A4), the information processing apparatuses start a function step interval timer (block A6). When the function step interval timer expires (YES in block A7), the information processing apparatuses check whether next function step is present (block A9). When next function step is present (NO in block A9), the information processing apparatuses repeat block A2 and subsequent steps. When next function step is not present (YES in block A9), the information processing apparatuses finish the process as “case a” (all function steps have been executed).

In the above operation flow, the information processing apparatuses check whether they are separated (blocks A5 and A8) during execution of function step [i] (block A4), or while the function step interval timer is operating (block A7). If they are not separated (NO in blocks A5 and A8), function step [i] is completed (YES in block A4), the function step interval timer expires (YES in block A7), and the information processing apparatuses go to block A9. If they are separated (YES in blocks A5 or A8), the information processing apparatuses finish the process as “case b” (function steps up to [i-1] have been executed) or “case c” (function steps up to [i] have been executed).

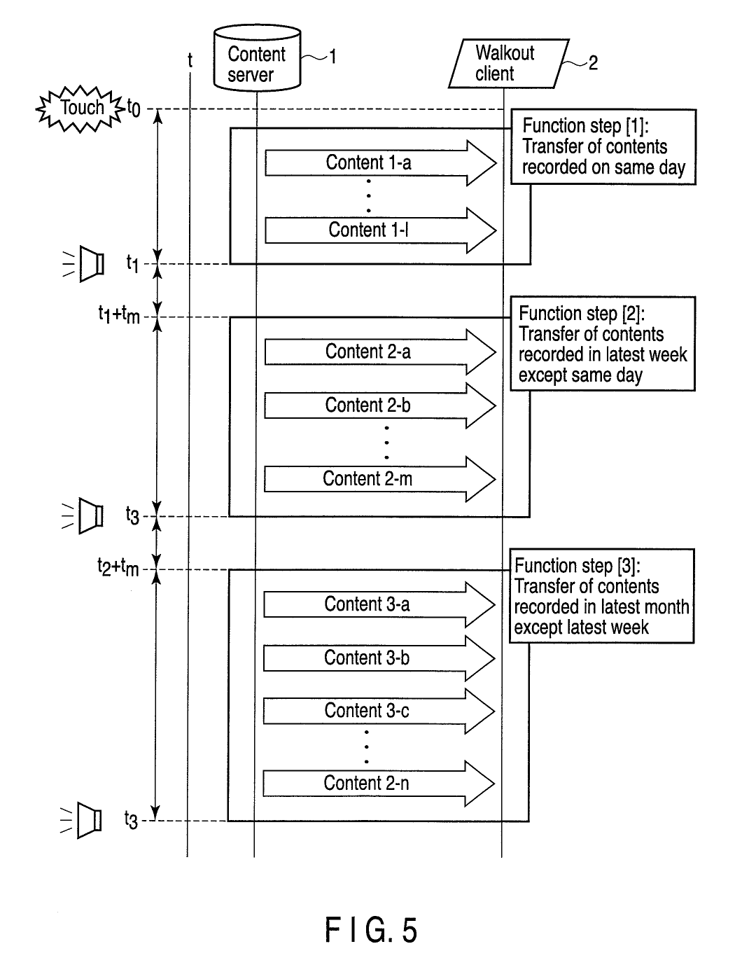

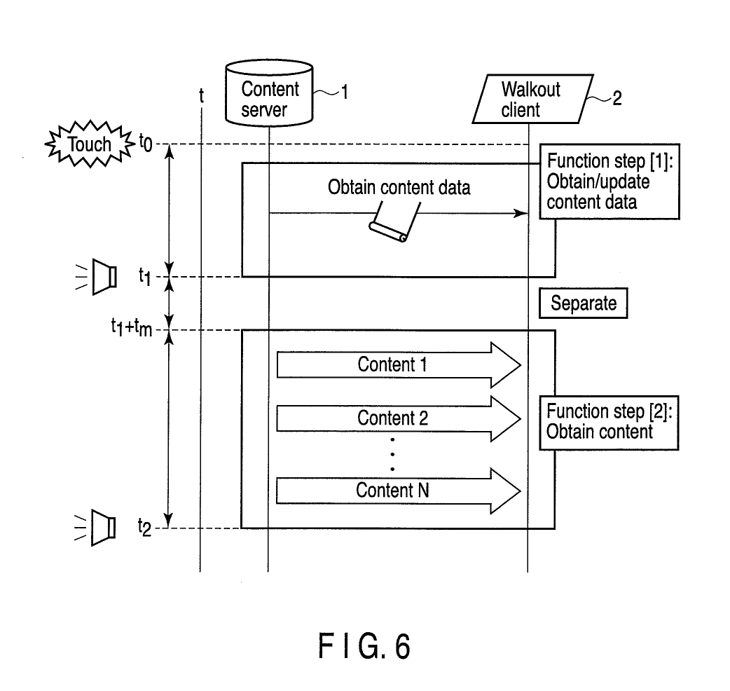

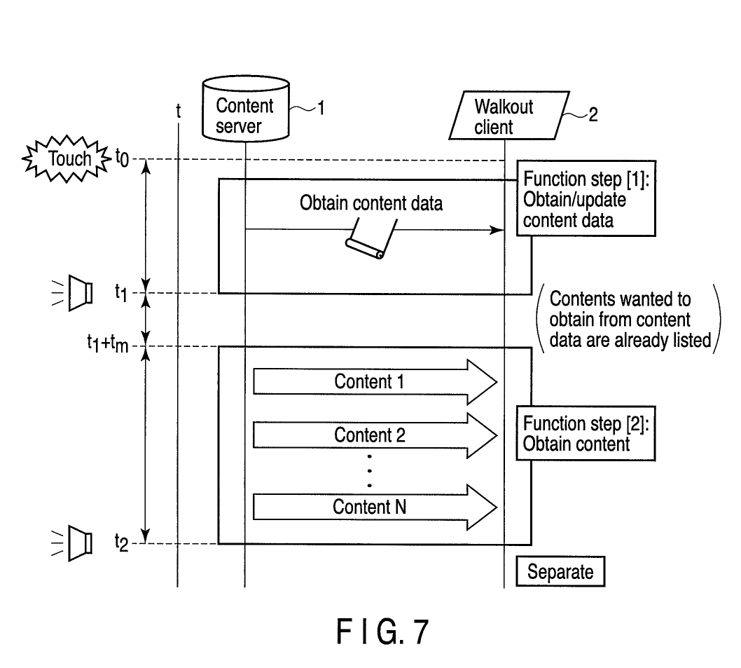

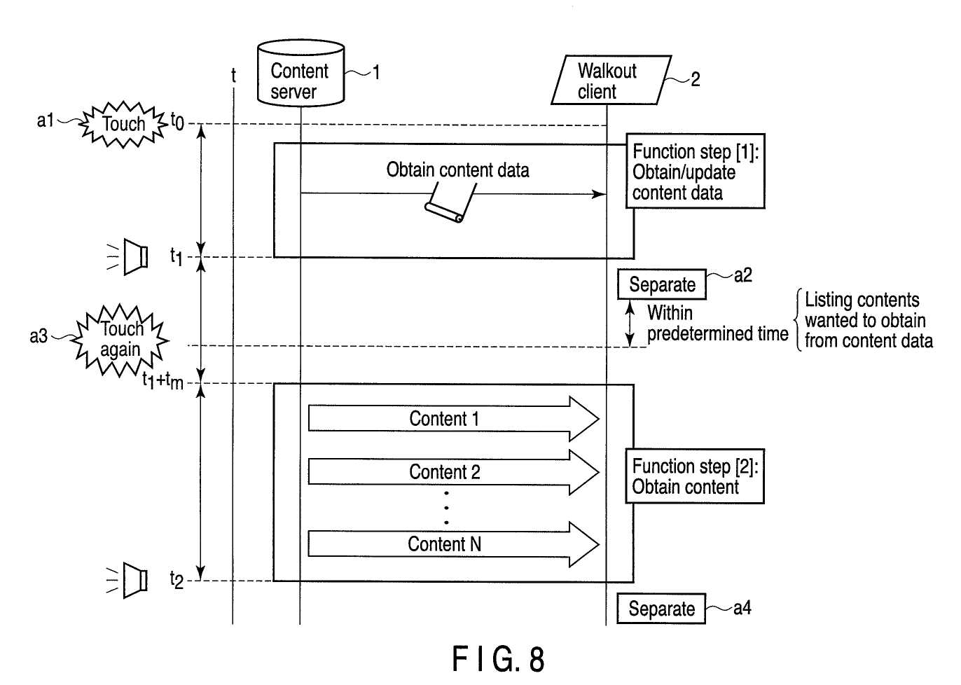

Next, an explanation will be given of application examples executable by the proximity wireless communication system using the information processing apparatus according to the embodiment with reference to FIG. 5, FIG. 6, FIG. 7 and FIG. 8.

### FIRST APPLICATION EXAMPLE

A first application example will be explained with reference to FIG. 5.

In the first application example, the PC 1 is assumed to include a television function including a function of receiving and recording a television broadcast program previously programmed to record. The cellphone 2 is assumed to include content reproduction software to reproduce various contents such as voice, video, and still image, including television broadcast program data. That is, the user can view television broadcast program data by the cellphone 2 by downloading the television broadcast program data recorded by the PC 1. In the first application example, a proximity wireless communication system is assumed to have been established, and television broadcast program data can be downloaded by touching the cellphone 2 to the PC 1. In FIG. 5, the PC 1 storing television broadcast data is indicated as a content server 1, and the cellphone 2 to download television broadcast program data is indicated as a walkout client 2.

A certain user (user A) wants to view a news program broadcast in the early morning of a day during travel to work by the cellphone 2. Another user (user B) wants to view the latest episodes of several dramas broadcast every week away from home by the cellphone 2. In such cases, user A wants to download only the television broadcast program data recorded on the same day to the cellphone 2, and user B wants to download the television broadcast program data recorded in the latest week.

In the first application example, as function step [1], the first step [1] processing module 102 for transmitting/receiving the television broadcast program data recorded on the same day is generated. As function step [2], the function step [2] processing module 102 for transmitting/receiving the television broadcast program data recorded in the latest week except the same day (already transmitted/received in function step [1]) is generated. Here, it is assumed that the function step [3] processing module 102 for transmitting/receiving the television broadcast program data recorded in the latest month except the latest week is also generated. Further, the function step [N] processing module 102 for transmitting/receiving all remaining television broadcast program data may be generated.

That is, users A and B are required to make no previous setting. User A is only required to touch the cellphone 2 to the PC 1 to emit sound, light, or a message the first time to notify completion of function step [1], and then separate the cellphone 2 from the PC1, before going to work. User B is only required to touch the cellphone 2 to the PC 1 to emit sound, light, or message second time to notify completion of function step [2], and then separate the cellphone 2 from the PC 1, in free time before going out.

That is, the process (execution) can be controlled only by simple actions of touching and separating the devices.

In the first application example, in which the cellphone 2 downloads the television broadcast program data recorded on the PC 1, it is preferable that a notice of completion of each function step is made by the cellphone 2 as a walkout client 2.

Here, television broadcast program data is transmitted stepwise based on the recording date and time. However, the data transmission order is not limited to this. For example, television broadcast program data can be transmitted stepwise in descending order of data size. In particular, a user who wants to download 30-minute or one-hour television broadcast program data to the cellphone 2 can download the data to the cellphone 2 as desired only by simple actions of touching and separating the devices.

### SECOND APPLICATION EXAMPLE

A second application example will be explained with reference to FIG. 6 and FIG. 7.

In the second application example, the PC 1 is assumed to include a content management function to obtain and manage music data through Internet. The cellphone 2 is assumed to include content reproduction software to reproduce various contents including music data. That is, the user can listen to music data by the cellphone 2 by downloading the music data managed on the PC 1. In the second application example, a proximity wireless communication system is assumed to have been established, and music data can be downloaded by touching the cellphone 2 to the PC 1. In FIG. 6 and FIG. 7, the PC 1 to manage music data is indicated as a content server 1, and the cellphone 2 to download music data is indicated as a walkout client 2.

A certain user (user C) does not grasp music data managed on the PC 1. User C wants to confirm existing music data, and wants to select desired music data, and download the selected music data. Another user (user D) has determined music data to be downloaded from the PC 1 to the cellphone 2.

In the second application example, as function step [1], the first step [1] processing module 102 for obtaining/updating a playlist of music data (content data) managed on the PC 1. As function step [2], the function step [2] processing module 102 for transmitting/receiving the music data playlist is generated.

As shown in FIG. 6, user C touches the cellphone 2 to the PC 1, emits sound, light, or a message the first time to notify the completion of function step [1], and separates the cellphone 2 from the PC1. This enables only obtaining/updating of content data, and stops subsequent function step of obtaining content at an appropriate timing.

User D makes a playlist of music data wanted to download based on the obtained content data, and then touches the cellphone 2 to the PC 1, as shown in FIG. 7. User C who obtained/updated content data and made a playlist of music data wanted to download in FIG. 6 is considered to be the same user as user D.

When the cellphone 2 is touched to the PC 1, first, function step [1] is started, and the content data is obtained/updated. When function step [1] is completed, sound, light, or a message is emitted the first time to notify the completion of function step [1]. User D does not separate the cellphone 2, and keep them in a proximity state. After a predetermined interval (time period tm), function step [2] is started, and the playlist of music data is transmitted/received. When sound, light or a message is emitted a second time to notify the completion of function step [2], user D may separate the cellphone 2 from the PC 1.

That is, the process (execution) can be controlled only by simple actions of touching and separating the devices.

In the second application example, in which the cellphone 2 downloads music data managed on the PC 1, it is preferable that a notice of completion of each function step is made by the cellphone 2 as a walkout client 2, as in the first application example.

As shown in FIG. 6, first, user C touches the cellphone 2 to the PC 1, and separates the cellphone 2 from the PC1 after sound, light, or a message is emitted the first time to notify the completion of function step [1], thereby obtaining/updating the content data. User C makes a playlist of music data wanted to download, touches the cellphone 2 to the PC 1, as shown in FIG. 7, and separates the cellphone 2 from the PC 1 after sound, light, or message is emitted second time to notify completion of function step [2], thereby transmitting the listed music data.

That is, user C executes function step [1] twice by making a playlist of music data wanted to download immediately after obtaining/updating content data, even when transmitting/receiving the listed music data.

Considering the above situation, the second application example is modified, so that when the proximity of two devices is restored within predetermined time, the subsequent function step is started. The modification of the second application example is explained with reference to FIG. 8.

As shown in FIG. 8, first, user C touches the cellphone 2 to the PC 1 (a1 in FIG. 8). Then, obtaining/updating of content data is started as function step [1]. When sound, light or a message is emitted the first time to notify the completion of function step [1], user C knows the completion of obtaining/updating of content data, and separates the cellphone 2 from the PC 1 for making a playlist of music data wanted to download (a2 in FIG. 8).

User C makes a playlist of music data wanted to download within a predetermined time, and touches the cellphone 2 again to the PC 1 (a3 in FIG. 8). When the proximity of the devices is restored within the predetermined time, function step [2] is started after a predetermined interval (time period tm) after the completion of function step [1]. That is, user C can transmit/receive the listed music data as function step [2] subsequent to function step [1].

As described above, the information processing apparatus according to the embodiment realizes control of the process (execution) including a plurality of steps (function steps) only by simple actions of touching and separating two devices.

In the above explanation, a process accompanied by data transmission is performed stepwise. However, a data transmission method is not limited to this. For example, operations of a device A sequentially executing a plurality of function steps in chronological order can be controlled by a device B. Specifically, the process (execution) including a plurality of steps (function steps) can be controlled by touching and separating a device B to/from a device A.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a communication module configured to execute proximity wireless communication;
a detector configured to detect whether an external device capable of executing proximity wireless communication with the communication module is in a proximity state; and
a controller configured to control execution of a series of operations comprising a plurality of steps based on detection of the proximity state and detection of a state other than the proximity state by the detector.

2. The apparatus of claim 1, wherein:
a time interval exists between two adjacent steps of the plurality of steps; and
the controller is configured to start the execution of the series of operations when the detector detects the proximity state, and to terminate the execution of the series of operations without starting a subsequent step when the detector detects the state other than the proximity state during the time interval after completion of any step.

3. The apparatus of claim 2, wherein the controller is configured to continue the execution of the series of operations when the detector detects the proximity state again within a time period after the detector detects the state other than the proximity state.

4. The apparatus of claim 1, wherein the controller comprises a notification module configured to provide a notification regarding completion of a step.

5. The apparatus of claim 4, further comprising a speaker, wherein the notification module is configured to provide an audible notification through the speaker.

6. The apparatus of claim 4, further comprising a display, wherein the notification module is configured to provide a visual notification through the display.

7. The apparatus of claim 1, wherein the series of operations comprises a series of operations for transmitting data items to the external device or receiving data items from the external device.

8. The apparatus of claim 7, wherein the plurality of steps in the series of operations are sequenced so that the data items are transmitted or received in ascending order of size.

9. The apparatus of claim 7, wherein the plurality of steps in the series of operations are sequenced so that the data items are transmitted or received in order of creation date and time or updating date and time.

10. A method of controlling for an information processing apparatus, the method comprising:
executing a series of operations comprising a plurality of steps using proximity wireless communication executed by a communication module;
detecting whether an external device capable of executing proximity wireless communication with the communication module is in a proximity state, and
controlling the execution of the series of operations based on detection of the proximity state and detection of a state other than the proximity state.

11. The method of claim 10, wherein:
a time interval exists between two adjacent steps of the plurality of steps; and
controlling execution of the series of operations comprises starting the execution of the series of operations when the proximity state is detected, and terminating the execution of the series of operations without starting a subsequent step when the state other than the proximity state is detected during the time interval after completion of any step.

12. The method of claim 11, wherein controlling execution of the series of operations comprises continuing the execution of the series of operations when the proximity state is detected again within a predetermined time period after the state other than the proximity state is detected.

13. The method of claim 10, wherein controlling the execution of the series of operations further comprises providing a notification regarding completion of a step.
